(19) United States
(12) Patent Application Publication
(10) Pub. No.: US 2025/0298590 A1
(43) Pub. Date: Sep. 25, 2025

(54) PROGRAM MANAGEMENT METHOD, ELECTRONIC DEVICE, AND STORAGE MEDIUM

(71) Applicant: Lenovo (Beijing) Limited, Beijing (CN)

(72) Inventors: Zhibin WANG, Beijing (CN); Yunwei GAO, Beijing (CN); Yumo YANG, Beijing (CN)

(21) Appl. No.: 19/085,684

(22) Filed: Mar. 20, 2025

(30) Foreign Application Priority Data
Mar. 20, 2024 (CN) 202410324438.9

(51) Int. Cl. G06F 8/41

(52) U.S. Cl. CPC G06F 8/41

(57) ABSTRACT

A program management method, an electronic device, and a storage medium are provided in the present disclosure. The program management method includes collecting a system message sent by at least one node terminal; receiving a program type and a program source code of an extended Berkeley packet filter (eBPF) program to be managed; compiling the program source code based on the program type and the system message sent by the at least one node terminal to obtain at least one eBPF program template; and distributing the at least one eBPF program template to the at least one node terminal, where the at least one eBPF program template is matched with the system message.

### CROSS-REFERENCE TO RELATED APPLICATION

This application claims the priority of Chinese Patent Application No. 202410324438.9, filed on Mar. 20, 2024, the content of which is incorporated herein by reference in its entirety.

### TECHNICAL FIELD

The present disclosure generally relates to the field of electronic technology, and, more particularly, relates to, a program management method, an electronic device, and a storage medium.

### BACKGROUND

Extended berkeley packet filter (eBPF) is a packet filtering technology that provides a mechanism for safely injecting code when kernel events and user program events occur, which may allow non-kernel developers to control kernels.

As eBPF-based projects grow larger, how to efficiently manage the eBPF programs becomes an important subject. However, existing solutions are inefficient in managing multiple eBPF programs.

### SUMMARY

One aspect of the present disclosure provides a program management method. The method includes collecting a system message sent by at least one node terminal; receiving a program type and a program source code of an extended Berkeley packet filter (eBPF) program to be managed; compiling the program source code based on the program type and the system message sent by the at least one node terminal to obtain at least one eBPF program template; and distributing the at least one eBPF program template to the at least one node terminal, where the at least one eBPF program template is matched with the system message.

Another aspect of the present disclosure provides an electronic device. The electronic device includes a memory, configured to store a computer program; and one or more processors, configured to, when the computer program is executed, perform a program management method. The method includes collecting a system message sent by at least one node terminal; receiving a program type and a program source code of an extended Berkeley packet filter (eBPF) program to be managed; compiling the program source code based on the program type and the system message sent by the at least one node terminal to obtain at least one eBPF program template; and distributing the at least one eBPF program template to the at least one node terminal, where the at least one eBPF program template is matched with the system message.

Another aspect of the present disclosure provides a non-transitory computer-readable storage medium, containing a computer program for when executed by one or more processors, performing a program management method. The method includes collecting a system message sent by at least one node terminal; receiving a program type and a program source code of an extended Berkeley packet filter (eBPF) program to be managed; compiling the program source code based on the program type and the system message sent by the at least one node terminal to obtain at least one eBPF program template; and distributing the at least one eBPF program template to the at least one node terminal, where the at least one eBPF program template is matched with the system message.

Other aspects of the present disclosure may be understood by those skilled in the art in light of the description, the claims, and the drawings of the present disclosure.

### BRIEF DESCRIPTION OF THE DRAWINGS

The accompanying drawings herein are incorporated into the specification and constitute a part of the specification. The accompanying drawings illustrate embodiments consistent with the present disclosure and are used together with the specification to illustrate technical solutions of the present disclosure. Obviously, the accompanying drawings described below are only certain embodiments of the present disclosure. For those skilled in the art, other drawings may be obtained based on the drawings without creative work.

The flowcharts shown in accompanying drawings may be only exemplary and may not necessarily include all contents and operations/steps and may not be executed in the order described in the present disclosure. For example, some operations/steps may be decomposed, while some other operations/steps may be combined or partially combined, such that actual execution order may change according to actual situation.

FIG. 1 illustrates an architecture diagram of a program management method according to various embodiments of the present disclosure.

FIG. 2 illustrates a flowchart of a program management method according to various embodiments of the present disclosure.

FIG. 3 illustrates another flowchart of a program management method according to various embodiments of the present disclosure.

FIG. 4 illustrates a flowchart of an exemplary program management method according to various embodiments of the present disclosure.

FIG. 5 illustrates a flowchart of a heterogeneous compilation method according to various embodiments of the present disclosure.

FIG. 6 illustrates a flowchart of template loading according to various embodiments of the present disclosure.

FIG. 7 illustrates a flowchart of a state feedback method according to various embodiments of the present disclosure.

FIG. 8A illustrates a structural schematic of a program management apparatus according to various embodiments of the present disclosure.

FIG. 8B illustrates another structural schematic of a program management apparatus according to various embodiments of the present disclosure.

FIG. 9 illustrates a structural schematic of an electronic device according to various embodiments of the present disclosure.

### DETAILED DESCRIPTION

In order to clearly describe the objectives, technical solutions and advantages of embodiments of the present disclosure, the technical solutions of the present disclosure are further described in detail below in conjunction with the drawings in embodiments of the present disclosure. Following embodiments are configured to illustrate the present disclosure but are not configured to limit the scope of the present disclosure. Unless otherwise defined, all technical and scientific terms used herein may have same meaning as those understood by those skilled in the art.

The terms used herein may be only for the purpose of describing embodiments of the present disclosure and may be not intended to limit the present disclosure. It can be understood that in the following description, “one embodiment” or “an embodiment” or “some embodiments” mentioned throughout the present disclosure may indicate that features, structures or characteristics related to embodiments may be included in at least one embodiment of the present disclosure. Therefore, “in one embodiment” or “in an embodiment” or “in some embodiments” mentioned throughout the present disclosure may not necessarily refer to same embodiment. Furthermore, features, structures or characteristics may be combined in one or more embodiments in any suitable manner without conflict.

It can be understood that in various embodiments of the present disclosure, the value of the sequence number of each process may not indicate the order of execution. The execution order of each process should be determined by function and internal logic and should not constitute any limitation on the implementation process of embodiments of the present disclosure. The sequence number of embodiments of the present disclosure may be only for description and may not represent the advantages and disadvantages of embodiments. The description of each embodiment above may emphasize the differences between embodiments, and same or similar parts may refer to each other, which may be not described in detail for the sake of brevity.

If similar descriptions of “first/second” mentioned in the present disclosure, following description is added. In the following description, the terms “first\second\third” used may be only configured to distinguish similar objects and may not represent a specific order of the objects. It can be understood that “first\second\third” may be interchanged with a specific order or sequence where permitted, such that described embodiments of the present disclosure may be implemented in an order other than that illustrated or described herein.

It can be understood by those skilled in the art that, unless otherwise defined, all terms used herein (including technical and scientific terms) may have same meaning as general understanding of those skilled in the art to which embodiments of the present disclosure belong. It should also be understood that terms, such as those defined in general dictionaries, should be understood to have meanings consistent with those terms in the context of the existing technology and may not be interpreted in an idealized or overly formal sense unless defined as herein.

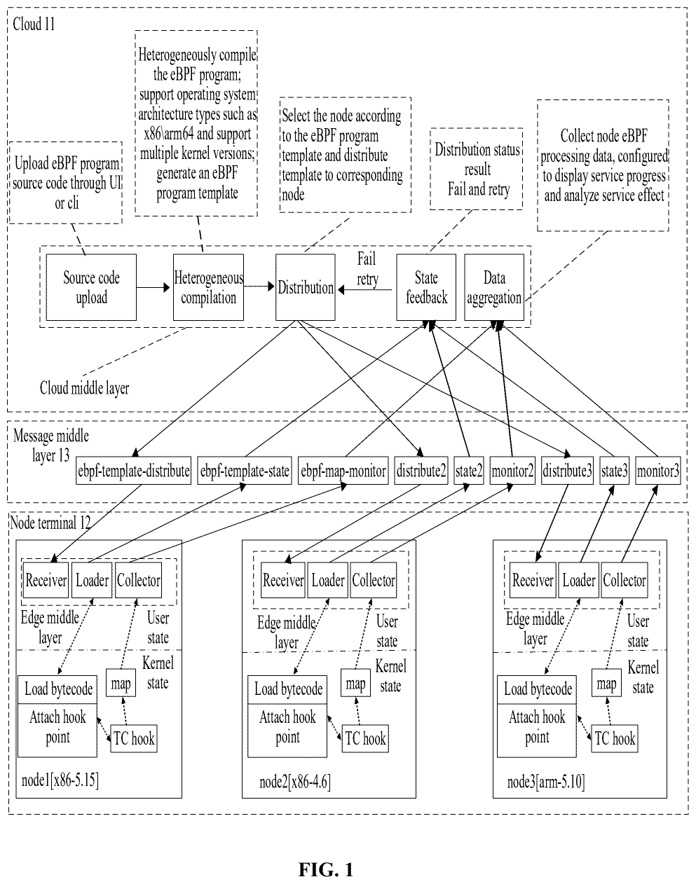

FIG. 1 illustrates an architecture diagram of a program management method according to various embodiments of the present disclosure. As shown in FIG. 1, a cloud 11, a node terminal 12, and a message middle layer 13 may be illustrated, where the cloud 11 may include a cloud middle layer, which be mainly configured to provide functions such as source code upload, heterogeneous compilation, distribution, state feedback, data aggregation and the like.

During the source code upload process, the user may upload complete eBPF program source code to the cloud middle layer through the UI or cli. During the heterogeneous compilation process, after receiving the eBPF program source code, the cloud middle layer may obtain the architecture types and operating system versions of all node terminals according to the type list of node terminals that already exist in the system and may heterogeneously compile the eBPF program. During the process of executing heterogeneous compilation to generate templates, in order to adapt to all node terminals, it needs to support operating system architecture types such as x86\arm64 and support multiple kernel versions; and finally, the eBPF program source code may be heterogeneously compiled to generate an eBPF program template. During the distribution process, the cloud middle layer may select the node terminal according to the eBPF program template and distribute the eBPF program template to corresponding node terminal. During the state feedback process, the cloud may obtain the distribution state result of the node terminal. in response to the distribution to corresponding node terminal fails, it needs to retry the distribution after failure, the distribution process may be re-entered, and the template may be sent to the node terminal that failed to load. During the data aggregation process, the cloud may collect node terminal eBPF processing data, which may be configured to display service progress and analyze service effect.

The node terminal 12 may include three nodes (i.e., node terminals), including the node terminal 1 (node [x86-5.15]), the node terminal 2 (node [x86-4.6]), and the node terminal 3 (node3 [arm-5.10]). Taking the node terminal 1 as an example, the node terminal 1 may include an edge middle layer, where the program of the node terminal 1 may include a kernel state and a user state, and the edge middle layer may mainly include a receiver, a loader, and a collector.

During an implementation process, the receiver may be configured to receive the eBPF program template sent by the cloud; the loader may be mainly configured to load the eBPF program template in the kernel state; the collector may be mainly configured to collect the service data generated when the target program is executed after the eBPF program template is loaded; and the loading process may mainly include loading bytecode, attaching hook point, TC hook, and map process. First, the bytecode of the eBPF program in the eBPF program template may be loaded; corresponding loading command may be executed by evaluating the eBPF type; the eBPF program may be attached to corresponding hook point to complete the attachment and hooking of the eBPF program; finally, the interaction data of the kernel state and the user state generated when the eBPF program is executed may be stored in a shared data structure. For example, the data structure may be a map.

The message middle layer 13 may include multiple types of message topics, such as ebpf-template-distribute (template distribution state 1), ebpf-template-state (template loading state 1), ebpf-template-monitor (template data collection 1), distribute2 (i.e., template distribution state 2), state2 (template loading state 2), monitor2 (template data collection 2), distribute3 (template distribution state 3), state3 (template loading state 3) and monitor3 (template data collection 3).

During an implementation process, the message middle layer 13 may be a component for realizing mutual communication between applications and may realize decoupling between applications, that is, messages may be forwarded through the message middle layer. For example, the message middle layer herein may be msg_broker.

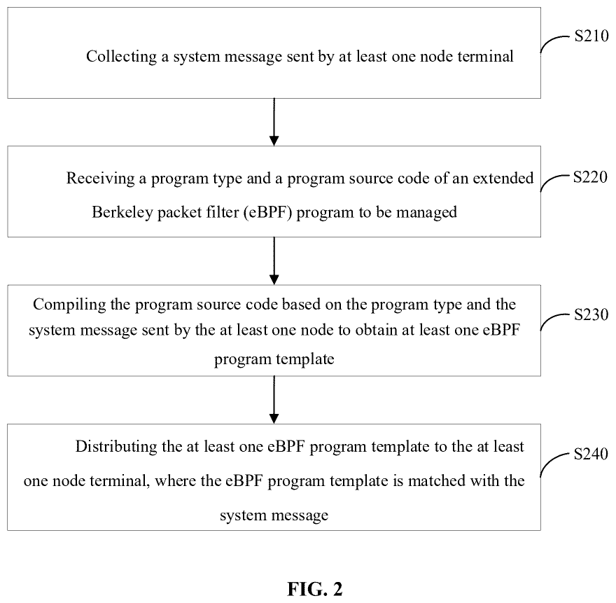

The present disclosure provides a program management method, which may be applied to the cloud. FIG. 2 illustrates a flowchart of a program management method according to various embodiments of the present disclosure. As shown in FIG. 2, the present disclosure may be implemented through S210, S220, S230 and S240.

At S210, the system message sent by at least one node terminal may be collected. The system message may at least include the architecture message and kernel message of the node terminal.

Architecture message refers to the architecture message of the operating system, including architecture type, operating system version and other message. For example, the architecture type may be x86 architecture or arm64 architecture; and the operating system version may be Windows 7 or Windows 10.

Kernel message refers to the most basic and core message of the operating system, including kernel version, kernel architecture and other message. For example, the kernel version may be linux5.15 or linux4.6.

At S220, the program type and program source code of an extended Berkeley packet filter eBPF program to be managed may be received.

Types of eBPF programs may be multiple. For example, a tracing eBPF program may be mainly configured to extract tracing message from the system, and the program types of the tracing eBPF program may include KPROBE, TRACEPOINT and PERF_EVENT; and a network eBPF program may be mainly configured to filter and process network data packets, and the program types of the network eBPF program may include eXpress Data Path (XDP) program, traffic control (TC) program, socket program and cgroup program.

At S230, the program source code may be compiled based on the program type and at least one system message to obtain at least one eBPF program template.

The compilation manner may adopt heterogeneous compilation. Heterogeneous compilation refers to using different compilation languages, different program types and different system message, and executing different compilation manners to compile the program.

During an implementation process, as shown in FIG. 1, the cloud 11 may obtain defined eBPF program template format according to the program type and the system message of at least one node terminal and perform heterogeneous compilation on the eBPF program source code to be managed to obtain at least one eBPF program template.

At S240, the eBPF program template may be distributed to the node terminal, where the eBPF program template may be matched with the system message.

During an implementation process, as shown in FIG. 1, the cloud 11 may distribute at least one eBPF program template to the node terminal through the message middle layer (msg-broker). During the distribution process, the cloud 11 may send matched eBPF program template to a corresponding node terminal according to the system message of the node terminal. For example, the node terminal 1 (node1 [x86-5.15]) may receive the eBPF program template corresponding to the architecture version of x86 and the kernel version of 5.15 in the eBPF program templates.

In embodiments of the present disclosure, the system message sent by the node terminal and the program source code and program type of the eBPF program to be managed uploaded by the user may be first obtained; the program source code may be then compiled based on the program type and system message to obtain the eBPF program template; and finally the eBPF program template may be sent to matched node terminal. In such way, the cloud may uniformly manage the eBPF programs to be managed, dynamically distribute the eBPF program templates to the node terminals in real time, and complete the update of the eBPF programs, which may realize collaboration between the cloud and the node terminals, thereby improving the efficiency of managing multiple eBPF programs.

In some embodiments, above-mentioned exemplary step S230 “the program source code may be compiled based on the program type and at least one system message to obtain at least one eBPF program template” may be implemented by following exemplary steps.

At one operational step, based on the kernel message, the compilation manner may be determined. Different compilation manners may be selected according to the kernel messages. Taking the kernel version 4.18 as an example, in response to the kernel version is greater than or equal to 4.18, the BTF (type format) compilation manner may be used; and in response to the kernel version is less than 4.18, the gcc, CMake, Makefile and other compilation manners may be used.

Based on the program type and the architecture message, the program source code may be compiled using the compilation manner to obtain at least one eBPF program template.

During an implementation process, the cloud may execute different compilation commands according to the program types and architecture messages and finally compile the program code in combination with the compilation manner to obtain the eBPF program template.

The program type may be configured to identify the eBPF program type in the eBPF program template, and the architecture message may be configured to identify the template to match corresponding node terminal.

During an implementation process, in response to the function points of the eBPF program change, such as the need to modify the eBPF program or add a new eBPF program, the cloud may only need to compile the program source code re-uploaded by the user to obtain a new eBPF program template and dynamically distribute the eBPF program template to the node terminal. The node terminal may reload new eBPF program template, and eBPF program function points may be updated without restarting basic service logic.

The eBPF program template may include at least one of the following messages, including the system message, the bytecode of the eBPF program to be managed, the program type, the program name, the execution manner of the eBPF program to be managed, and the data structure of the eBPF program to be managed.

In some embodiments, taking the x86 architecture and kernel version 5.15.0 as an example, the eBPF template generated after compilation may include the eBPF bytecode compiled under the x86 architecture and 5.15.0 kernel version, the hook point and eBPF program type to which the eBPF bytecode is attached, the eBPF program name, the map list (name, type) that the eBPF program needs to access, and the structure BTF bytecode defined when adapting across kernel versions. The eBPF template may include different contents according to different kernel versions and different eBPF program types. For example, when the kernel is less than 4.18, the exporttypes field may be reduced.

The eBPF template is shown as the following, where the field bpf_object denotes the eBPF bytecode, bpf_size denotes the eBPF bytecode size, arch denotes the architecture version, kernel_version denotes the kernel version, hook_point denotes the hook point to which the eBPF bytecode is attached, type denotes the eBPF program type, obj_name denotes the eBPF program name, progs denotes the parameter list, link denotes the parameter type, name denotes the parameter name, maps denotes the eBPF program data structure, name denotes the data name, type denotes the data type, export_types denotes other type lists, export_btf denotes other types of bytecode, structs denotes the structure, id denotes the structure number, and name denotes the structure name:

```
{
  “bpf_object”: “xxxxxxxxxxxxxxxxxxxxxxxxxxxx...”,
  “bpf_size”: 1024,
  “meta”: {
    “arch”: “x86”,
    “kernel_version”: “5.15.0”,
    “hook_point”: “eth0”,
    “type”: “tc_ingress”,
    “bpf_skel”: {
      “obj_name”: “tc_ingress_bpf”,
      “progs”: { |
        {
          “link”: true,
          “name”: “package_filter”
        }
      ],
      “maps”: [
        {
          “name”: “tc_ingress_map”,
          “type”: “hash”
        },
        {
          “name”: “tc_ingress_array”,
          “type”: “prog_array”
        }
      ]
    },
    “export_types”: {
      “export_btf”: “xxxxxxxxxxxxxxxxxxxxxxxxxxxx...”,
      “structs”: [{
        “id”: 2,
        “name”: “event”
      }]
    }
  }
}
```

In embodiments of the present disclosure, the compilation manner may be first determined based on the kernel message, the program source code may be then compiled using the compilation manner based on the program type and architecture message, and finally the eBPF program template may be obtained. The eBPF program to be managed may be converted into a universal format eBPF program template which may no longer depend on certain environment, and multiple templates corresponding to different node terminals may be generated by batch compilation, thereby improving the efficiency of managing multiple eBPF programs.

In some embodiments, above-mentioned program management method may also be implemented by following exemplary steps.

At one operational step, the loading result obtained by loading the eBPF program template sent by each node terminal may be received. The loading result may include the result of successful loading, loading failure, and verification failure.

At one operational step, the eBPF program template on the target node may be determined to have verification failure based on the loading result. Verification failure refers to a problem when the eBPF program template generated in the cloud is verified on the node terminal.

During an implementation process, in response to an eBPF program template dead loop occurs, the eBPF program template is damaged to the kernel or an unauthorized operation occurs in the eBPF program template at the verification process, the node terminal may set the loading result to the verification failure and return (i.e., feedback) the loading to the cloud.

At one operational step, the eBPF program to be managed may be recompiled to obtain a recompiled eBPF program template.

At one operational step, the recompiled eBPF program template may be sent to the target node terminal.

During an implementation process, in response to the loading result fed back by the node terminal is verification failure, the cloud may need to recompile the eBPF program to be managed to avoid verification failure of the eBPF program template again. After the compilation, the cloud may need to resend the compiled eBPF program template to the target node terminal.

In embodiments of the present disclosure, the cloud may determine the state feedback result of the node terminal. in response to the loading result is verification failure, the eBPF program to be managed may need to be recompiled, and regenerated eBPF program template may be sent to the target node terminal, which may improve the security and correctness of the eBPF program template.

In some embodiments, above-mentioned program management method may also be implemented by following exemplary steps.

At one operational step, the service data sent by each of the node terminals may be received, where the service data may be obtained by running the target program at the node terminal, and the target program may be obtained by loading the eBPF program template at the node terminal.

During an implementation process, the node terminal may obtain the target program after completing the loading of the eBPF program template. By running the target program, the service interaction data of the user state and the kernel state may be generated. The node terminal may upload such part of data to the cloud, such that the cloud may perform service display and service analysis.

At one operational step, based on the service data, service analysis may be performed.

The cloud may perform service analysis. The cloud may analyze the service data of each node terminal, or aggregate and compare the service data of multiple node terminals. Embodiments of the present disclosure may not limit the analysis manner.

In embodiments of the present disclosure, the cloud may process service logic and service analysis separately by collecting service data of each node terminal and performing service analysis based on the service data. The service data and service logic may be managed separately without affecting each other, thereby improving data management efficiency of multiple eBPF programs.

The present disclosure provides a program management method, which may be applied to the node terminal. FIG. 3 illustrates another flowchart of a program management method according to various embodiments of the present disclosure. As shown in FIG. 3, the present disclosure may be implemented through S310 and S320.

At S310, the extended Berkeley packet filter eBPF program template sent by the cloud may be received, where the eBPF program template may be obtained by the cloud compiling the program source code of the eBPF program to be managed based on the system message of the node terminal and the program type of the eBPF program to be managed.

Referring to FIG. 1, the receiver of the node terminal 12 may receive the task of distributing the eBPF template by subscribing to the ebpf-template-distribute topic message and send the task to the loader of the middle layer after completely receiving the eBPF template.

At S320, the eBPF program template may be loaded based on the program type to obtain the target program.

During an implementation process, the loader at the node terminal may receive the eBPF program template and execute different loading commands according to the program type of the eBPF program template. During the loading process, the eBPF program template may be verified. When the verification passes and the loading is completed, the target program may be obtained.

In embodiments of the present disclosure, the node terminal may obtain the target program by receiving the eBPF program template sent by the cloud and loading the eBPF program template. The cloud may manage the eBPF program source code in a centralized manner, and the node terminal may manage corresponding eBPF program according to the eBPF program template generated by the cloud. Therefore, the cloud may manage the service strategies of eBPF in batches, and the node terminal may also adjust needed service strategy in real time according to the program template to achieve cloud-edge collaboration, thereby improving management efficiency of multiple eBPF programs.

In some embodiments, before above-mentioned exemplary step S310 “receiving the extended Berkeley packet filter eBPF program template sent by the cloud”, the method may further include following process: sending the system message of the node terminal to the cloud, where the system message may include the architecture message and kernel message of the node terminal.

In embodiments of the present disclosure, the system message of the node terminal may be sent to the cloud, such that the cloud may generate corresponding eBPF program template according to the system message and send generated eBPF program template to a corresponding node terminal according to the system message of each node terminal, thereby ensuring the correctness of the cloud distribution of the eBPF program template.

In some embodiments, above-mentioned exemplary step S320 “loading the eBPF program template based on the program type to obtain the target program” may also be implemented by following exemplary steps.

At one operational step, based on the program type, the loading command may be determined.

The loading command may be determined according to the program type in the eBPF program template. During an implementation process, the program type of tc_ingress may be taken as an example, and the loading command may be “tc filter replace dev eth0 ingress prio 1 5 handle 1/bpf da obj my_prog.o”.

At one operational step, based on the loading command, the eBPF program template may be verified in the process of loading the eBPF program template.

At one operational step, when it determines that the eBPF program template is verified, the target program may be obtained.

Template verification refers to that when the node terminal loads the eBPF program template, the eBPF program template may be first verified. Verification manners may include syntax rule verification, permission verification, security verification and the like.

In embodiments of the present disclosure, the loading command may be first determined according to the program type, and the eBPF program template may be then loaded using the loading command. A verifier may be configured to verify the eBPF program template, and finally the target program after loading may be obtained. In such way, the node terminal may use the eBPF program template to obtain the target program to be executed, which may make the loading steps to be simple, feasible and convenient for maintenance.

In some embodiments, above-mentioned “obtaining the target program when it determines that the eBPF program template is verified” may also be implemented by following exemplary steps.

At one operational step, it determines that the eBPF program template is verified, and loading the eBPF program template is failed.

At one operational step, the eBPF program template may be reloaded to obtain the target program that has been reloaded.

During an implementation process, in response to it determines that the eBPF program template is verified but failed to load due to other errors, the eBPF program template may need to be reloaded. Other errors refer to errors that cause loading failure on the node terminal. For example, other errors may be that a device state may not satisfy loading requirement, or the loader may have problems.

In embodiments of the present disclosure, when the eBPF program template fails to be loaded due to other errors on the node terminal, the eBPF program template may need to be reloaded. In such way, the loading of the eBPF program template may be ensured to be completed correctly, thereby improving management efficiency of the eBPF program on the node terminal.

In some embodiments, the program management method may further include following exemplary steps.

At 330, when it determines that the eBPF program template fails to be verified, the loading result of verification failure may be sent to the cloud.

At 340, the recompiled eBPF program template may be reloaded to obtain the target program that has been reloaded, where the recompiled eBPF program template may be obtained through recompiling the eBPF program to be managed by the cloud.

In embodiments of the present disclosure, when it determines that the loading result is verification failure, the node terminal may send the loading result to the cloud, and the cloud may recompile the eBPF program template according to the loading result, and the node terminal may reload the recompiled eBPF program template. In such way, the correctness of the eBPF program template may be guaranteed, and the reliability of the node terminal managing the eBPF program may be ensured.

In some embodiments, the program management method may further include following exemplary steps.

At 350, the service data generated by running the target program may be collected.

At 360, the service data may be uploaded to the cloud.

The service data refers to the service data generated by the interaction between the user state and the kernel state when the target program is running and may be saved in the map. The map may be a data structure for saving the data shared and interacted between the user state and the kernel state.

In embodiments of the present disclosure, the node terminal may collect the service data generated by running the target program and upload the service data to the cloud, such that the cloud may display and analyze the service based on the service data.

eBPF may provide a mechanism for safely injecting code when kernel events and user program events occur, such that non-kernel developers may also control the kernel. eBPF is increasingly widely used, but the distribution of eBPF programs is not convenient. eBPF programs may be divided into user-state programs and kernel-state programs. The kernel-state program may be attached to the hook point, which may need to go through operations such as compilation (c program→eBPF bytecode), loading, and attachment and the like. As eBPF-based projects become larger, how to efficiently manage above-mentioned eBPF programs has become an important issue.

For existing solution 1, simple eBPF programs, such as monitoring eBPF programs, may use the manner of binding the user-state programs and the kernel-state programs. That is, the user-state program may not only include compilation, loading, attachment and other operations of the kernel-state eBPF program but also include the service logic of the interaction between the user-state (program) and the kernel-state.

Above solution 1 may not meet the management of multiple eBPF programs.

For existing solution 2, complex eBPF programs may use a unified script to manage kernel-state eBPF programs. For example, in a cilium project, init.sh may be configured to manage the compilation, loading, and attachment of all kernel-state eBPF programs in the project.

In above solution 2, all eBPF programs may be included in one mirror, and the target architecture may not be identified, and automatic distribution may not be performed. Furthermore, such method may not dynamically manage eBPF programs. When a certain eBPF program needs to be updated, entire node terminal may need to be interrupted for version update. Finally, such method may not have cloud-edge collaboration capability and may not adjust and apply different eBPF programs in real time according to cloud policies.

To solve above-mentioned problems, the present disclosure provides a program management method, which may be applied in the cloud and the node terminal. In embodiments of the present disclosure, the cloud may be a cloud server that provides basic cloud computing services such as cloud services, cloud databases, cloud computing, cloud functions, cloud storage, network services, cloud communications, middleware services, domain name services, security services, CDN (content delivery network), and big data and artificial intelligence platforms and the like. The node terminal may be a server, which may be an independent physical server, or a server cluster or distributed system including multiple physical servers, which may be not limited in embodiments of the present disclosure.

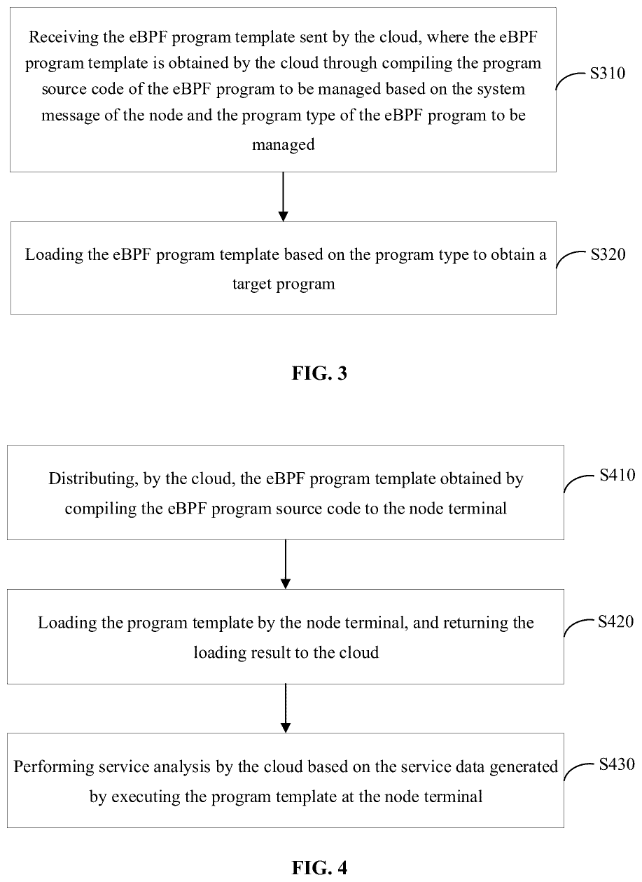

Embodiments of the present disclosure provides an exemplary application in an actual application scenario as shown in FIG. 4. The exemplary application may include following exemplary steps.

At S410, the cloud may distribute the eBPF program template obtained by compiling the eBPF program source code to the node terminal.

The eBPF program template may include messages such as compiled eBPF bytecode, bytecode size, bytecode compilation architecture, corresponding kernel version and the like.

During an implementation process, an intermediate layer may be deployed on the cloud and the node terminal respectively. The cloud intermediate layer may be configured to manage the eBPF source code and heterogeneously compile the eBPF bytecode and generate the eBPF template for certain node terminal type (such as x86+kernel 5.10); and according to service needs, may dynamically distribute the eBPF templates of different architectures or kernel versions to the node terminal intermediate layer.

At S420, the node terminal may load the program template and return (feedback) the loading result to the cloud.

During an implementation process, after the node terminal receives the template, the template may be loaded; and the middle layer of the node terminal may complete the attachment or update of the eBPF program and return (feedback) the loading result to the cloud.

At S430, the cloud may perform service analysis based on the service data generated by executing the program template at the node terminal.

During an implementation process, the cloud may collect the node terminal eBPF processing data uploaded by the node terminal for displaying service progress and analyzing service effect.

In embodiments of the present disclosure, firstly, the cloud may obtain the eBPF program template, which may make the eBPF program a more universal format and no longer rely on a certain environment. Secondly, the cloud may distribute the template generated by compiling the program source code to the node terminal, which may realize real-time dynamic distribution of the eBPF program on the cloud without restarting basic service logic, thereby realizing the update of certain eBPF function points. Finally, the node terminal may load the program template sent by the cloud and return (feedback) the loading result and service data to the cloud, which may realize cloud-edge collaboration and distinguish different types of edge node terminals. The cloud may manage the service strategies of eBPF in batches, and the node terminal may also adjust the service strategy needed in real time.

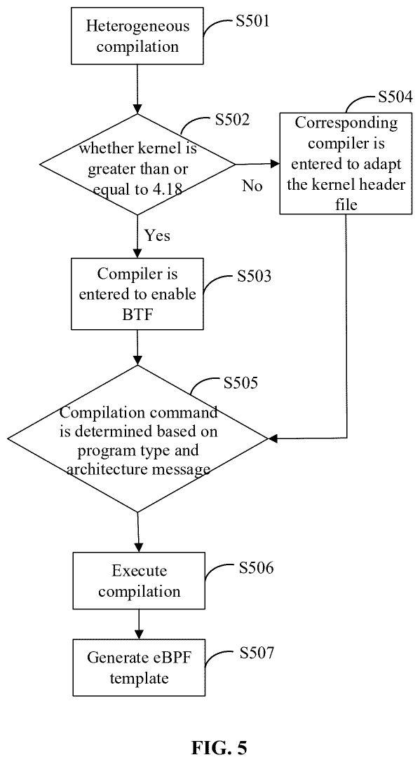

During an implementation process, referring to FIG. 5, the execution process of above-mentioned exemplary step S410 “the cloud distributes the eBPF program template obtained by compiling the eBPF program source code to the node terminal” may include following exemplary steps.

At S501, heterogeneous compilation may be performed.

At S502, whether kernel is greater than or equal to 4.18 may be determined.

During an implementation process, the cloud may first select corresponding compilation manner according to the kernel message. Taking the kernel greater than or equal to 4.18 as an example, in response to yes, execute exemplary step S503; and in response to not, execute exemplary step S504.

At S503, the compiler may be entered to enable BTF.

During an implementation process, when the kernel version is greater than or equal to 4.18, the BTF compilation manner may be used.

At S504, corresponding compiler may be entered to adapt the kernel header file.

During an implementation process, when the kernel version is less than 4.18, corresponding compilation manner may be selected according to the kernel version.

At S505, the compilation command may be determined based on the program type and the architecture message.

At S506, the compilation may be executed.

At S507, the eBPF template may be generated.

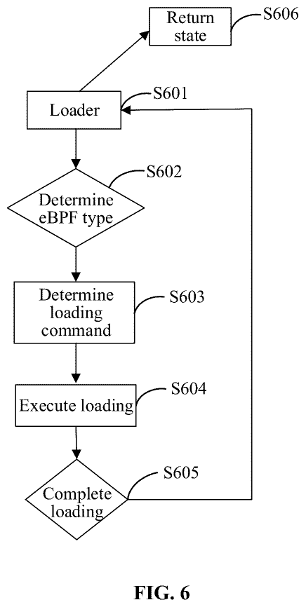

In some embodiments, for above-mentioned exemplary step S420 “the node terminal loads the program template and returns the loading result to the cloud”, referring to FIG. 6, the execution process of the node terminal loading the program template may include following exemplary steps.

At S601, the loader may be started.

During an implementation process, the node terminal may start to load the eBPF program template in the loader.

At S602, the eBPF type may be determined.

During an implementation process, the eBPF program type may be found from the eBPF program template.

At S603, the loading command may be determined.

During an implementation process, the loading command may be determined according to the eBPF program type.

At S604, loading may be executed.

During an implementation process, the node terminal may use the loading command to load the eBPF program template, and the eBPF program template may be also verified during the loading process.

At S605, loading may be completed.

At S606, the state may be returned (feedback).

During an implementation process, after the loading is completed, the node terminal may use the loader to feedback the state, which may feedback the loading result to the cloud.

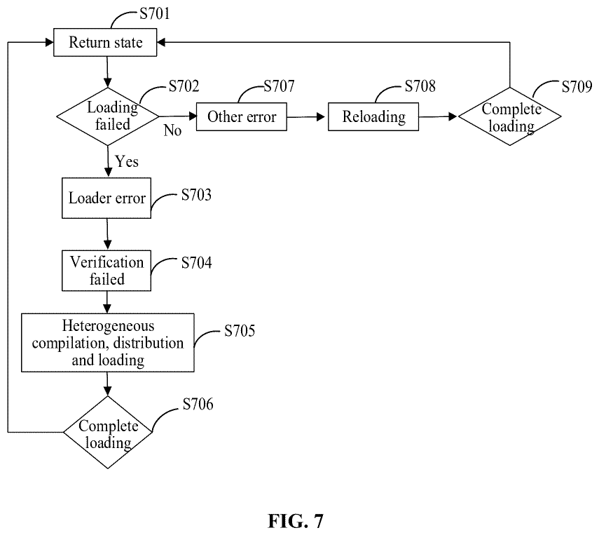

In some embodiments, for above-mentioned exemplary step S420 “the node terminal loads the program template and returns the loading result to the cloud”, referring to FIG. 7, the execution process of the node terminal returning the loading result to the cloud may include following exemplary steps.

At S701, the state may be returned (fed back).

During an implementation process, the node terminal may use the loader to obtain final loading result, and the usage state of the loading result may be returned to the cloud.

At S702, the loading may be failed.

During an implementation process, in response to final loading result is loading failure, there are two main reasons for the loading failure of the node terminal, including verifier error and other errors. In response to verifier error, execute exemplary step S703; and in response to not verifier error, execute exemplary step S707.

At S703, the verifier may have error.

The error herein refers to the error that occurs when the verifier checks the eBPF program template, such as the template syntax does not conform to the rules, the template is damaged to the kernel and the like.

At S704, verification may be failed.

At S705, heterogeneous compilation, distribution and loading may be performed.

During an implementation process, in response to the verification fails, the cloud may need to recompile the managed eBPF program heterogeneously and distribute compiled eBPF program template to corresponding node terminal.

At S706, loading may be completed.

The node terminal may reload the eBPF program template sent by the cloud and

send the loading result to the cloud through the state feedback.

At S707, other errors may be detected.

Other errors refer to loading failures caused by own device of the node terminal, for example, the device state does not meet loading, the loader has problems and the like.

At S708, reloading may be performed.

During an implementation process, for the loading failure of the node terminal template caused by other errors, the cloud may not need to compile again, and the node terminal may need to reload received eBPF program template once and send the loading result to the cloud through the state feedback.

At S709, loading may be completed.

After the loading is completed, the node terminal may send the loading result to the cloud through the state feedback.

Based on above-mentioned embodiments, embodiments of the present disclosure provide a program management apparatus, which may be applied to the cloud. The apparatus 800 may include modules and sub-modules included in each module, which may be implemented by a processor in an electronic device and may also be implemented by a certain logic circuit. In an implementation process, the processor may be a central processing unit (CPU), a microprocessor (MPU), a digital signal processor (DSP) or a field programmable gate array (FPGA) or the like.

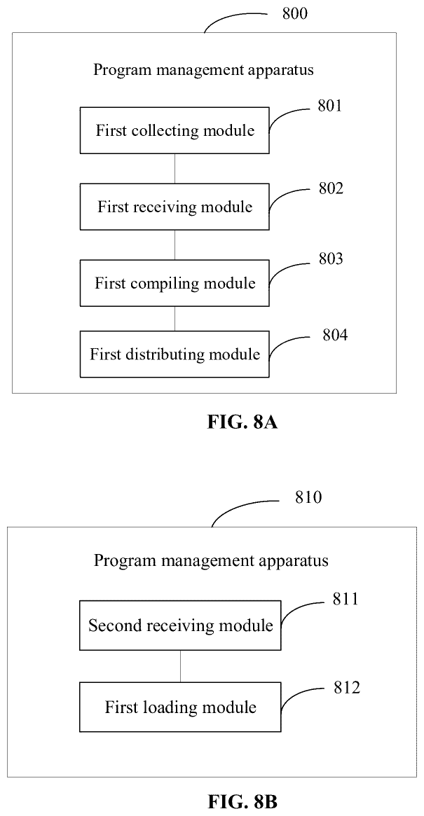

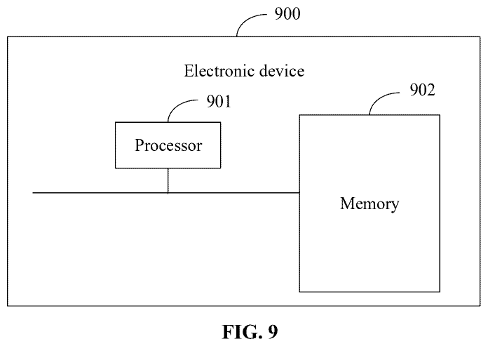

As shown in FIG. 8A, the program management apparatus 800 may include the first collecting module 801 configured to collect the system message sent by at least one node terminal; the first receiving module 802 configured to receive the program type and the program source code of the extended Berkeley packet filter eBPF program to be managed; the first compiling module 803 configured to compile the program source code based on the program type and at least one system message to obtain at least one eBPF program template; and the first distributing module 804 configured to distribute the eBPF program template to the node terminal, where the eBPF program template may be matched with the system message.

In some embodiments, the first compiling module 803 may further include the first determining submodule and the first compiling submodule, where the first determining submodule may be configured to determine the compilation mode based on the kernel message; and the first compiling submodule may be configured to compile the program source code using the compilation mode based on the program type and the architecture message to obtain at least one eBPF program template.

In some embodiments, the apparatus 800 may further include the third receiving module, the first determining module, the second compiling module and the first sending module, where the third receiving module may be configured to receive the loading result which is sent by each node terminal and obtained based on loading the eBPF program template; the first determining module may be configured to determine the verification failure of the eBPF program template of the target node terminal based on the loading result; the second compiling module may be configured to recompile the eBPF program to be managed to obtain recompiled eBPF program template; and the first sending module may be configured to send recompiled eBPF program template to the target node terminal.

In some embodiments, the apparatus 800 may further include the fourth receiving module and the first analyzing module. The fourth receiving module may be configured to receive the service data sent by each node terminal, where the service data may be obtained by the node terminal running the target program, and the target program may be obtained by the node terminal loading the eBPF program template; and the first analyzing module may be configured to perform service analysis based on the service data.

Based on above-mentioned embodiments, the present disclosure provides a program management apparatus, which may be applied to the node terminal. The apparatus 810 may include modules and the submodules included in each module, which may be implemented by a processor in an electronic device. As shown in FIG. 8B, the program management apparatus 810 may include the second receiving module 811 configured to receive the extended Berkeley packet filter eBPF program template sent by the cloud, where the eBPF program template may be obtained by the cloud compiling the program source code of the eBPF program to be managed based on the system message of the node terminal and the program type of the eBPF program to be managed; and include the first loading module 812 configured to load the eBPF program template based on the program type to obtain the target program.

In some embodiments, the apparatus 810 may further include the first sending module, configured to send the system message of the node terminal to the cloud, where the system message may include the architecture message and the kernel message of the node terminal.

In some embodiments, the first loading module 812 may further include the second determining submodule, the first verifying submodule, and the third determining submodule, where the second determining submodule may be configured to determine the loading command based on the program type; the first verifying submodule may be configured to verify the eBPF program template in the process of loading the eBPF program template based on the loading command; and the third determining submodule may be configured to determine that the target program may be obtained when the eBPF program template passes the verification.

In some embodiments, the third determining submodule may further include the fourth determining submodule and the first loading submodule, where the fourth determining submodule may be configured to determine that the eBPF program template has passed the verification and failed to load; and the first loading submodule may be configured to reload the eBPF program template to obtain the target program that has been reloaded.

In some embodiments, the apparatus 810 may further include the second sending module and the third loading module, where the second sending module may be configured to, when verification of the eBPF program template is determined to be failed, send the loading result of verification failure to the cloud; and the third loading module may be configured to reload recompiled eBPF program template to obtain the target program that has been reloaded, where the recompiled eBPF program template may be obtained through recompiling the eBPF program to be managed by the cloud.

In some embodiments, the apparatus 810 may further include the second collecting module and the first uploading module, where the second collecting module may be configured to collect service data generated by running the target program, and the first uploading module may be configured to upload the service data to the cloud.

The description of above-mentioned apparatus embodiments may be similar to the description of above-mentioned method embodiments and have similar beneficial effects as the method embodiments. Technical details not disclosed in apparatus embodiments of the present disclosure may refer to the description of method embodiments of the present disclosure for understanding.

Based on the program management methods of above-mentioned embodiments, embodiments of the present disclosure further provide an electronic device. As shown in FIG. 9, a device 900 may include a processor 901 and a memory 902. The memory 902 may be configured to store a computer program; and the processor 901 may be configured to call and run the computer program from the memory 902, thereby executing the program management methods as described in above-mentioned embodiments.

In embodiments of the present disclosure, the processor 901 may be at least one of an application specific integrated Circuit (ASIC), a digital signal processor (DSP), a digital signal processing device (DSPD), a programmable logic device (PLD), a field programmable gate array (FPGA), a central processing unit (CPU), a controller, a microcontroller, and a microprocessor. It may be understood that for different devices, the electronic device configured to implement above-mentioned processor function may also be other types, which may not be limited in embodiments of the present disclosure.

Based on the program management methods of above-mentioned embodiments, embodiments of the present disclosure provide a computer-readable storage medium, where the computer program may be stored. The computer program may implement above program management method when executed by the processor. In embodiments of the present disclosure, above storage medium may include various media for storing program codes, such as a mobile storage device, a read-only memory (ROM), a disk or an optical disk, and may also be other media, which may be not limited by embodiments of the present disclosure.

Exemplarily, the program instructions corresponding to the program management methods in one embodiment may be stored on a storage medium such as a CD, a hard disk, or a USB flash drive. When the program instructions corresponding to the program management methods in the storage medium are read or executed by an electronic device, the program management methods described in any of above-mentioned embodiments may be implemented.

Based on the program management methods of above-mentioned embodiments, embodiments of the present disclosure provide a computer program product, including the computer program or the instruction. Exemplary steps of above program management methods may be implemented when the computer program or the instruction is executed by the processor. When implementing the program management methods of above-mentioned embodiments, the division of above program modules may merely be used as an example. In practical applications, above processes may be assigned to different program modules as needed. That is, the internal structure of the apparatus may be divided into different program modules to complete all or a part of the processes described above. Furthermore, the program management apparatus provided in above-mentioned embodiment may belong to same concept as the program management methods in embodiments of the present disclosure. The implementation process and beneficial effects of the program management apparatus may refer to method embodiments, which may not be repeated in detail herein. Technical details not disclosed in embodiments of the apparatus may refer to the description of method embodiments of the present disclosure for understanding.

Various embodiments of the present disclosure further provide a non-transitory computer-readable storage medium, containing a computer program for when executed by one or more processors, performing a program management method. The method includes collecting a system message sent by at least one node terminal; receiving a program type and a program source code of an extended Berkeley packet filter (eBPF) program to be managed; compiling the program source code based on the program type and the system message sent by the at least one node terminal to obtain at least one eBPF program template; and distributing the at least one eBPF program template to the at least one node terminal, where the at least one eBPF program template is matched with the system message.

Compared with the existing technology, the technical solutions provided by the present disclosure may achieve at least the following beneficial effects.

In embodiments of the present disclosure, firstly, the system message sent by at least one node terminal may be collected; the program type and the program source code of the extended Berkeley packet filter (eBPF) program to be managed may be received; the program source code may be compiled based on the program type and the system message sent by the at least one node terminal to obtain at least one eBPF program template; and finally the at least one eBPF program template may be distributed to the at least one node terminal, where the at least one eBPF program template is matched with the system message. In such way, the cloud may manage the eBPF programs to be managed in a centralized manner, dynamically distribute the eBPF program templates to the node terminals in real time, and complete the update of the eBPF programs, which may realize collaboration between the cloud and the node terminals, thereby improving the efficiency of managing multiple eBPF programs.

Those skilled in the art may understand that all or a part of exemplary steps of implementing above-mentioned method embodiments may be completed by hardware related to program instructions, and above-mentioned program may be stored in a computer-readable storage medium. When the program is executed, exemplary steps of embodiments of above-mentioned program management methods may be executed.

It should be understood by those skilled in the art that embodiments of the present disclosure may be provided as methods, systems, or computer program products. Therefore, the present disclosure may take the form of hardware embodiments, software embodiments, or embodiments combining software and hardware. Moreover, the present disclosure may take the form of a computer program product implemented on one or more computer-usable storage media (including but not limited to disk storage and optical storage and the like) containing computer-usable program codes.

The present disclosure is described with reference to the flowcharts and/or block diagrams of the methods, apparatuses, devices (systems), and computer program products according to embodiments of the present disclosure. It can be understood that each process and/or box in the flowchart and/or block diagram, as well as the combination of processes and/or boxes in the flowchart and/or block diagram, may be implemented by computer program instructions. The computer program instructions may be provided to processors of a general-purpose computer, a special-purpose computer, an embedded processor, or other programmable data processing device to produce a machine. In such way, the instructions executed by the processor of the computer or other programmable data processing device may generate an apparatus for implementing functions specified in one or more processes in the flowchart and/or one or more boxes in the block diagram.

The computer program instructions may also be stored in a computer-readable memory that may guide a computer or other programmable data processing device to work in certain manner, such that the instructions stored in the computer-readable memory may generate a product including an instruction apparatus that implements functions specified in one or more processes of the flowchart and/or one or more boxes of the block diagram. The computer program instructions may also be loaded onto a computer or other programmable data processing device, such that a series of exemplary operation steps may be performed on the computer or other programmable device to generate computer-implemented processing. Therefore, the instructions executed on the computer or other programmable device may provide exemplary steps for implementing functions specified in one or more processes of the flowchart and/or one or more boxes of the block diagram.

The above may merely be implementation manners of embodiments of the present disclosure, which may not limit the protection scope of embodiments of the present disclosure. Any changes or substitutions performed by those skilled in the art within the technical scope disclosed in the present disclosure should be included in the protection scope of embodiments of the present disclosure. Therefore, the protection scope of embodiments of the present disclosure should be based on the protection scope of the claims.

What is claimed is:

1. A program management method, comprising:
collecting a system message sent by at least one node terminal;
receiving a program type and a program source code of an extended Berkeley packet filter (eBPF) program to be managed;
compiling the program source code based on the program type and the system message sent by the at least one node terminal to obtain at least one eBPF program template; and
distributing the at least one eBPF program template to the at least one node terminal, wherein the at least one eBPF program template is matched with the system message.

2. The method according to claim 1, wherein:
the system message includes an architecture message and a kernel message of the at least one node terminal; and
compiling the program source code based on the program type and the system message sent by the at least one node terminal to obtain the at least one eBPF program template includes:
based on the kernel message, determining a compilation manner; and
based on the program type and the architecture message, compiling the program source code using the compilation manner to obtain the at least one eBPF program template.

3. The method according to claim 1, further including:
receiving a loading result obtained by loading an eBPF program template and sent by each node terminal;
determining that the eBPF program template of a target node terminal fails to be verified based on the loading result;
recompiling the eBPF program to be managed to obtain a recompiled eBPF program template; and
sending the recompiled eBPF program template to the target node terminal.

4. The method according to claim 1, further including:
receiving service data sent by each node terminal, wherein the service data is obtained by running a target program on each node terminal, and the target program is obtained by loading the eBPF program template on each node terminal; and
based on the service data, performing service analysis.

5. The method according to claim 1, wherein:
the at least one eBPF program template includes at least one of following messages including the system message, a bytecode of the eBPF program to be managed, a program type, a program name, an execution manner of the eBPF program to be managed, and a data structure of the eBPF program to be managed.

6. The method according to claim 1, further including:
receiving an eBPF program template sent by a cloud, wherein the eBPF program template is obtained by the cloud through compiling the program source code of the eBPF program to be managed based on the system message of the at least one node terminal and the program type of the eBPF program to be managed; and
loading the eBPF program template based on the program type to obtain a target program.

7. The method according to claim 6, before receiving the eBPF program template sent by the cloud, further including:
sending the system message of the at least one node terminal to the cloud, wherein the system message includes an architecture message and a kernel message of the at least one node terminal.

8. The method according to claim 6, wherein loading the eBPF program template based on the program type to obtain the target program includes:
based on the program type, determining a loading command;
based on the loading command, verifying the eBPF program template during a loading process of the eBPF program template; and
in response to a determination that the eBPF program template passes verification, obtaining the target program.

9. An electronic device, comprising:
a memory, configured to store a computer program; and
one or more processors, configured to, when the computer program is executed, perform:
collecting a system message sent by at least one node terminal;
receiving a program type and a program source code of an extended Berkeley packet filter (eBPF) program to be managed;
compiling the program source code based on the program type and the system message sent by the at least one node terminal to obtain at least one eBPF program template; and
distributing the at least one eBPF program template to the at least one node terminal, wherein the at least one eBPF program template is matched with the system message.

10. The electronic device according to claim 9, wherein:
the system message includes an architecture message and a kernel message of the at least one node terminal; and
compiling the program source code based on the program type and the system message sent by the at least one node terminal to obtain the at least one eBPF program template includes:
based on the kernel message, determining a compilation manner; and
based on the program type and the architecture message, compiling the program source code using the compilation manner to obtain the at least one eBPF program template.

11. The electronic device according to claim 9, wherein the one or more processors are further configured to:
receive a loading result obtained by loading an eBPF program template and sent by each node terminal;
determine that the eBPF program template of a target node terminal fails to be verified based on the loading result;
recompile the eBPF program to be managed to obtain a recompiled eBPF program template; and
send the recompiled eBPF program template to the target node terminal.

12. The electronic device according to claim 9, wherein the one or more processors are further configured to:
receive service data sent by each node terminal, wherein the service data is obtained by running a target program on each node terminal, and the target program is obtained by loading the eBPF program template on each node terminal; and
based on the service data, perform service analysis.

13. The electronic device according to claim 9, wherein:
the at least one eBPF program template includes at least one of following messages including the system message, a bytecode of the eBPF program to be managed, a program type, a program name, an execution manner of the eBPF program to be managed, and a data structure of the eBPF program to be managed.

14. The electronic device according to claim 9, wherein the one or more processors are further configured to:
receive an eBPF program template sent by a cloud, wherein the eBPF program template is obtained by the cloud through compiling the program source code of the eBPF program to be managed based on the system message of the at least one node terminal and the program type of the eBPF program to be managed; and
load the eBPF program template based on the program type to obtain a target program.

15. The electronic device according to claim 14, wherein before receiving the eBPF program template sent by the cloud, the one or more processors are further configured to:
send the system message of the at least one node terminal to the cloud, wherein the system message includes an architecture message and a kernel message of the at least one node terminal.

16. The electronic device according to claim 14, wherein the one or more processors are further configured to:
based on the program type, determine a loading command;
based on the loading command, verify the eBPF program template during a loading process of the eBPF program template; and
in response to a determination that the eBPF program template passes verification, obtain the target program.

17. A non-transitory computer-readable storage medium containing a computer program that when being executed, causes one or more processors to perform:
collecting a system message sent by at least one node terminal;
receiving a program type and a program source code of an extended Berkeley packet filter (eBPF) program to be managed;
compiling the program source code based on the program type and the system message sent by the at least one node terminal to obtain at least one eBPF program template; and
distributing the at least one eBPF program template to the at least one node terminal, wherein the at least one eBPF program template is matched with the system message.

18. The storage medium according to claim 17, wherein:
the system message includes an architecture message and a kernel message of the at least one node terminal; and
compiling the program source code based on the program type and the system message sent by the at least one node terminal to obtain the at least one eBPF program template includes:
based on the kernel message, determining a compilation manner; and
based on the program type and the architecture message, compiling the program source code using the compilation manner to obtain the at least one eBPF program template.

19. The storage medium according to claim 17, wherein the one or more processors are further configured to:
receive a loading result obtained by loading an eBPF program template and sent by each node terminal;
determine that the eBPF program template of a target node terminal fails to be verified based on the loading result;
recompile the eBPF program to be managed to obtain a recompiled eBPF program template; and
send the recompiled eBPF program template to the target node terminal.

20. The storage medium according to claim 17, wherein the one or more processors are further configured to:
receive service data sent by each node terminal, wherein the service data is obtained by running a target program on each node terminal, and the target program is obtained by loading the eBPF program template on each node terminal; and
based on the service data, perform service analysis.
